(19) United States
(12) Patent Application Publication
(10) Pub. No.: US 2020/0373786 A1
(43) Pub. Date: Nov. 26, 2020

(54) A SYSTEM AND APPARATUS FOR WIRELESS POWER TRANSFER

(71) Applicants: Wenwei Yu, Chiba (JP); SINGAPORE UNIVERSITY OF TECHNOLOGY AND DESIGN, Singapore (SG)

(72) Inventors: Wenwei Yu, Chiba (JP); Shaoying Huang, Singapore (SG); Wenshen Zhou, Singapore (SG); - Omkar, Singapore (SG)

(73) Assignee: Singapore University of Technology and Design, Singapore (SG)

(21) Appl. No.: 16/763,811

(22) PCT Filed: Nov. 14, 2018
(86) PCT No.: PCT/SG2018/050569

§ 371 Date: May 13, 2020

(30) Foreign Application Priority Data
Nov. 15, 2017 (SG) 10201709402R
Sep. 7, 2018 (SG) 10201807722P

(51) Int. Cl. H02J 50/12; H01F 38/14; H02J 50/40; H02J 50/70

(52) U.S. Cl. CPC H02J 50/12; H02J 50/70; H02J 50/40; H01F 38/14

(57) ABSTRACT

A wireless power transmitter apparatus including a transmit resonator having a resonant frequency; and a transmit coil located within the transmit resonator; wherein the transmit resonator is configured to inductively couple to a receive resonator having a resonant frequency that is the same as the resonant frequency of the transmit resonator to thereby transmit power to the receive resonator.

The present application claims priority under 35 U.S.C. § 119 to Singaporean Application Nos. 10201709402R filed on Nov. 15, 2017 and 10201807722P filed on Sep. 7, 2018, and under 35 U.S.C. § 365 to International Application No. PCT/SG2018/050569 filed on Nov. 14, 2018. The entire contents of these applications are incorporated herein by reference in their entirety.

### BACKGROUND

The present disclosure relates to a system and apparatus for wireless power transfer.

Wireless Power Transfer (WPT) was first proposed by Nikola Tesla in the late 19th century. However, the applications of WPT were limited until relatively recently due to the lack of good materials, semiconductor switches, and capacitors.

Recent rapid development of consumer electronics, electric vehicles, implantable devices and other relevant industries has increased interest in WPT systems. For example, wireless charging devices have gained much interest amongst consumers of late due to the ability for phones to be charged wirelessly which reduces the need for cumbersome cables. Cables often require replacing due to wear and tear and different devices may have different charging systems which require different cables resulting in inconveniences for a user who needs to carry around multiple cables.

Currently, typical wireless charging systems require a device being charged to be placed at a pre-determined orientation at a wireless charging dock. This is due to the need for a transmit coil of wireless inductive charging device to line up with a receive coil of the device to be charged, typically at very close range. Misalignment between the respective receive and transmit coils often results in inefficient power transfer or even no power transfer. This is inconvenient to the user as the user will need to align the device in a desirable orientation, and ensure that the desirable orientation is maintained during the power transfer process.

A particular implementation of WPT includes inductive power transfer (IPT) which utilises inductive coupling. IPT is non-radiative and works in near field ranges i.e. short-range or mid-range. Typical inductive coupling utilizes the mutual induction between two coils and supports short-range wireless power transfer, e.g. within the range of centimetres.

A way of extending the distance from short-range to mid-range is by inducing inductive coupling at resonance or resonant inductive coupling—this technique is also called magnetic resonance coupling, IPT with resonance, or resonant IPT. Resonant inductive coupling techniques employ two strongly coupled resonators which have the same resonant frequency to enhance transfer efficiency. The resonance between the resonators boosts up the coupling between the transmitter coil and the receiving coil and extends the transfer distance. This technique is suited to mid-range applications such as gadget charging and powering in-body/on-body biomedical devices.

A limitation in resonant inductive coupling systems is that the transfer efficiency or transmission efficiency between the transmitter and receiver coils is low. This results in a reduced power transfer. This is of particular concern when resonant inductive coupling systems are applied to a human-involved environment. In a human-involved environment, the position and orientation of the transmitter and receiver coils are often misaligned. For example, movement of a cell phone in the pocket of a human subject or of an ingestible device in the human body often results in misalignments between the coils. This results in a decrease in efficiency for such WPT systems.

In order to have high transmission efficiency, it is often desirable to have a high quality factor for most resonant inductive coupling systems. However, this often results in a narrow bandwidth of the system. This is often disadvantageous in human-involved environments as the resonant frequency of the WPT component often shifts when it is installed in the human body, on skin or when there is human interference. This is because the human body is lossy and inhomogeneous, with high dielectric constants. A resonant frequency mismatch will result in significant drops of the transfer efficiency.

It is generally desirable to overcome or ameliorate one or more of the above described difficulties, or to at least provide a useful alternative.

### SUMMARY OF THE DISCLOSURE

In accordance with embodiments of the present disclosure, there is provided a wireless power transmitter apparatus including:
(a) a transmit resonator having a resonant frequency; and
(b) a transmit coil located within the transmit resonator;
wherein the transmit resonator is configured to inductively couple to a receive resonator having a resonant frequency that is the same as the resonant frequency of the transmit resonator to thereby transmit power to the receive resonator.

In accordance with embodiments of the present disclosure, there is also provided a wireless power receiver apparatus including:
(a) a receive resonator having a resonant frequency; and
(b) a receive coil located within the receive resonator;
wherein the receive resonator is configured to inductively couple to a transmit resonator having a resonant frequency that is the same as the resonant frequency of the receive resonator to thereby receive power from the transmit resonator.

In accordance with embodiments of the present disclosure, there is also provided a wireless power transmitter apparatus, including a transmit resonator having a resonant frequency; and a transmit coil configured to electromagnetically couple to the transmit resonator; wherein the transmit resonator is configured to inductively couple to a receive resonator having a resonant frequency that is the same as the resonant frequency of the transmit resonator to thereby transmit power to the receive resonator; and wherein the transmit resonator comprises an ellipsoidal helical coil.

In accordance with embodiments of the present disclosure, there is also provided a wireless power receiver apparatus, including: a receive resonator having a resonant frequency; and a receive coil configured to electromagnetically couple to the receive resonator; wherein the receive resonator is configured to inductively couple to a transmit resonator having a resonant frequency that is the same as the resonant frequency of the receive resonator to thereby receive power from the transmit resonator; and wherein the receive resonator comprises an ellipsoidal helical coil.

### BRIEF DESCRIPTION OF THE DRAWINGS

Some embodiments of the invention are hereafter described, by way of non-limiting example only, with reference to the accompanying drawings in which:

FIG. 1 shows a schematic side-on view of a system for wireless power transfer;

FIG. 2 shows a schematic side-on view of a prior art system for wireless power transfer;

FIG. 3 shows simulated and measured transmission coefficients S₂₁ of the systems of FIGS. 1 and 2;

FIG. 4 shows an equivalent circuit diagram for the systems of FIGS. 1 and 2;

FIG. 5 shows efficiency η as a function of κ with varying κ values;

FIG. 6 shows an example of a test setup of a resonator and tx/rx coil;

FIG. 7a shows a schematic side-on view of a conventional WPT system with a cylindrical resonant coil;

FIG. 7b shows a schematic side-on view of a system according to certain embodiments, having an ellipsoidal resonant coil;

FIG. 8a shows a side view of an example ellipsoidal resonant coil having a sinusoidal helix shape outline;

FIG. 8b shows a top view of an example ellipsoidal resonant coil having a sinusoidal helix shape outline;

FIG. 9a shows side view of an example ellipsoidal resonant coil having a circular helix shape outline;

FIG. 9b shows a top view of an example ellipsoidal resonant coil having a circular helix shape outline;

FIG. 10a shows a side view of example ellipsoidal resonant coil having a linear helix shape outline;

FIG. 10b shows a top view of an example ellipsoidal resonant coil having a linear helix shape outline;

FIG. 11a shows a side view of an example ellipsoidal resonant coil having a concave helix shape outline;

FIG. 11d shows a top view of an example ellipsoidal resonant coil having a concave helix shape outline;

FIG. 12 shows tapering functions of the shapes of the example ellipsoidal resonant coils as shown in FIGS. 8 to 11;

FIG. 13 shows simulated efficiencies of example ellipsoidal resonant coils as shown in FIGS. 8, 9, 10 and example cylindrical resonant coil as shown in FIG. 7a;

FIG. 14a shows exemplary magnetic field of simulated example cylindrical resonant coil as shown in FIG. 7a at resonance (47.51 MHz);

FIG. 14b shows exemplary magnetic field of simulated example cylindrical resonant coil as shown in FIG. 7a at off-resonant state (60.51 MHz);

FIG. 15a shows exemplary magnetic field of simulated example ellipsoidal resonant coil as shown in FIG. 7b at resonance (53.45 MHz);

FIG. 15b shows exemplary magnetic field of simulated example ellipsoidal resonant coil as shown in FIG. 7b at off-resonant state (40.95 MHz);

FIG. 16a shows a side view of an example ellipsoidal resonant coil as shown in FIG. 7b that has a sinusoidal helix shape outline;

FIG. 16b shows a side view of an example ellipsoidal resonant coil as shown in FIG. 7b that has a sinusoidal helix shape outline that is compressed in direction A_{c};

FIG. 16c shows a side view of an example ellipsoidal resonant coil as shown in FIG. 7b that has a sinusoidal helix shape outline that is stretched in direction Aₛ;

FIG. 17 shows simulated efficiencies of example ellipsoidal resonant coils having different axial scalings, as shown in FIGS. 16a, 16b and 16c;

FIG. 18a shows a side view of an example ellipsoidal resonant coil as shown in FIG. 7b that has a sinusoidal helix shape outline;

FIG. 18b shows a side view of an example ellipsoidal resonant coil as shown in FIG. 7b that has a sinusoidal helix shape outline that is compressed in direction T_{c};

FIG. 18c shows a side view of an example ellipsoidal resonant coil as shown in FIG. 7b that has a sinusoidal helix shape outline that is stretched in direction Tₛ;

FIG. 19 shows simulated efficiencies of example ellipsoidal resonant coils of different transversal scalings as shown in FIGS. 18a, 18b and 18c;

FIG. 20a shows a front view of an example fabricated cylindrical resonant coil as shown in FIG. 7a;

FIG. 20b shows a front view of a example fabricated ellipsoidal resonant coil as shown in FIG. 7b that has a circular helix shape outline as shown in FIGS. 9a and 9b;

FIG. 21 shows a front view of an example experimental setup of ellipsoidal resonant coil as shown in FIG. 20b;

FIG. 22a shows example capacitors used in example experimental setup as shown in FIG. 21;

FIG. 22b shows schematic diagram of example experimental setup as shown in FIG. 21;

FIG. 23a shows exemplary measured efficiency of a CHS system using example fabricated cylindrical resonant coil as shown in FIG. 20a and a SHS system using example fabricated ellipsoidal resonant coil as shown in FIG. 20b at edge-to-edge distances of 20 cm, 30 cm, and 40 cm;

FIG. 23b shows maximal efficiency of an example CHS system and an example SHS system at various edge-to-edge distances;

FIG. 24a shows angle of misalignment between transmit and receive coils of an example ellipsoidal resonant coil as shown in FIG. 7b that has a sinusoidal helix shape outline;

FIG. 24b shows angle of misalignment between transmit and receive coils of an example cylindrical resonant coil as shown in FIG. 7a;

FIG. 24c shows simulated transmission efficiency of the ellipsoidal system with coils as shown in FIG. 24a and cylindrical system with coils as shown in FIG. 24b at various misalignment angles, θ;

FIG. 25a shows an example ellipsoidal system with semi-ellipsoidal helical resonant coils;

FIG. 25b shows another example ellipsoidal system with semi-ellipsoidal helical resonant coils and reflection walls; and

FIG. 26a shows simulated efficiency of an example ellipsoidal system as shown in FIG. 25a;

FIG. 26b shows simulated efficiency of an example ellipsoidal system as shown in FIG. 25b with various gaps of 20 mm, 40 mm and 80 mm.

### DETAILED DESCRIPTION

### Placement of Transmit and Receive Coils

In resonant inductive coupling systems, it is advantageous to increase the transfer efficiency from a transmit coil to a receive coil to minimize power losses. In systems according to certain embodiments, the placement of transmit and receive coils within corresponding resonators, i.e. the transmit resonant coil and receive resonant coil respectively, may increase the efficiency of power transfer between the transmit and receive coils.

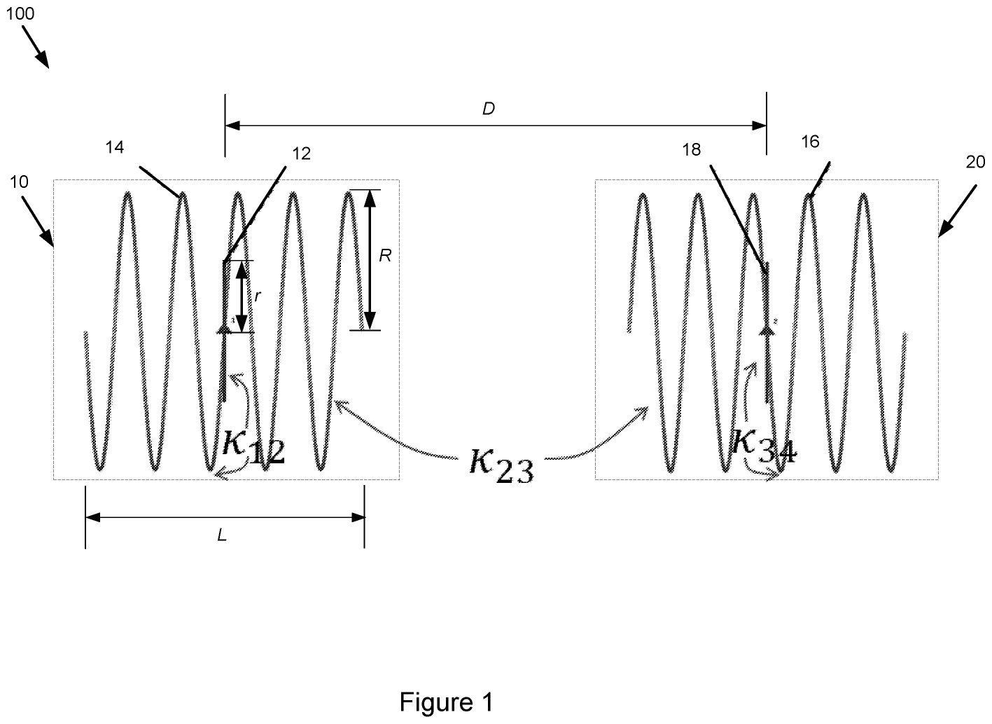

Referring to FIG. 1, a wireless power transfer system 100 according to certain embodiments includes a transmit apparatus 10 and a receive apparatus 20.

A transmitter apparatus 10 for wireless power transfer may include:
(a) a transmit resonator (e.g. transmit resonant coil 14) having a resonant frequency f0; and
(b) a transmit coil 12 located within the transmit resonant coil 14;
wherein the transmit resonant coil 14 is configured to be inductively coupled to a receive resonator (e.g. receive resonant coil 16) having the same resonant frequency f0, e.g. by magnetic resonance coupling, characterised by coupling coefficient K₂₃, for transmitting power from the transmit coil 12 of the transmitter 10 to a receive coil 18 of the receiver 20.

Advantageously, the transmit coil 12 may be located substantially centrally within the transmit resonant coil 14. This ensures maximal coupling between the transmit coil 12 and the transmit resonant coil 14, thereby improving the efficiency of power transmission.

A receiver apparatus 20 for wireless power transfer may include:
(a) a receive resonator (e.g. receive resonant coil 16) having a resonant frequency f0; and
(b) a receive coil 12 located within the receive resonant coil 16;
wherein the receive resonant coil 16 is configured to be inductively coupled to a transmit resonator (e.g. transmit resonant coil 14), e.g. by magnetic resonance coupling, characterised by coupling coefficient K₂₃, for receiving power from a transmit coil 12 at the receive coil 14.

Advantageously, the receive coil 18 is located substantially centrally within the receive resonant coil 16.

A system 100 for wireless power transfer may include the transmitter 10 and the receiver 20, wherein the transmit resonant coil 14 of the transmitter 10 is configured to be coupled to the receive resonant coil 16 of the receiver 20 by magnetic resonance coupling, characterised by coupling coefficient K₂₃, for transmitting power from the transmit coil 12 to the receive coil 18.

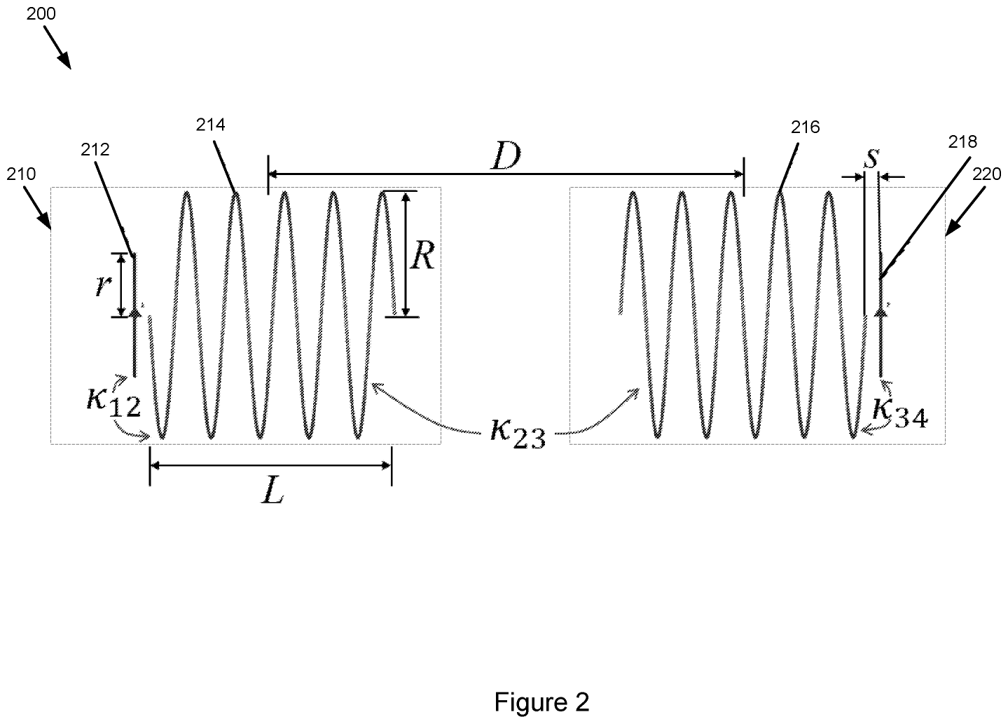

FIG. 2 shows a conventional system 200 including conventional transmit apparatus 210 and conventional receive apparatus 220 where a conventional transmit coil 212 and conventional receive coil 218 are placed outside the conventional transmit resonant coil 214 and conventional receive resonant coil 216 respectively. Advantageously, as mentioned above, system 100 is more efficient and has higher bandwidth than the conventional system 200, by virtue of the transmit and receive coils being placed within, rather than outside, the respective resonators.

### Verification Model Simulation

Simulations of the system 100 and system 200 were performed to verify that system 100 performs better than conventional system 200. This was done by way of full wave simulations conducted using CST Microwave Studio. The frequency domain solver was used.

As shown in FIGS. 1 and 2, R is the radius of the resonant coils 14, 16, 214 and 216, r is the radius of the transmit and receive coils 12, 18, 212 and 218, D is the distance between the center of the transmit resonant coil 14, 214 and receive resonant coil 16 and 216, and r_{w} is the radius of the wire. For example, the wire (resonant coils, receive and/or transmit coils) can be made of copper. Of course, the wire can be made of any other suitable material, such as silver, and may be formed by 3D printing, for example. As shown in FIG. 2, s is the spacing between the transmit coil 212 and the receive coil 218 and their corresponding resonant coils 214, 216.

In the simulations, the following parameters were applied:
R=40 mm
r=20 mm
L=80 mm
D=400 mm
s=5 mm
r_{w}=0.5 mm

In the simulation, two discrete ports were applied at the transmit coils 12, 212, and the receive coils 18, 218, respectively as well as the S-parameters of the two-port network.

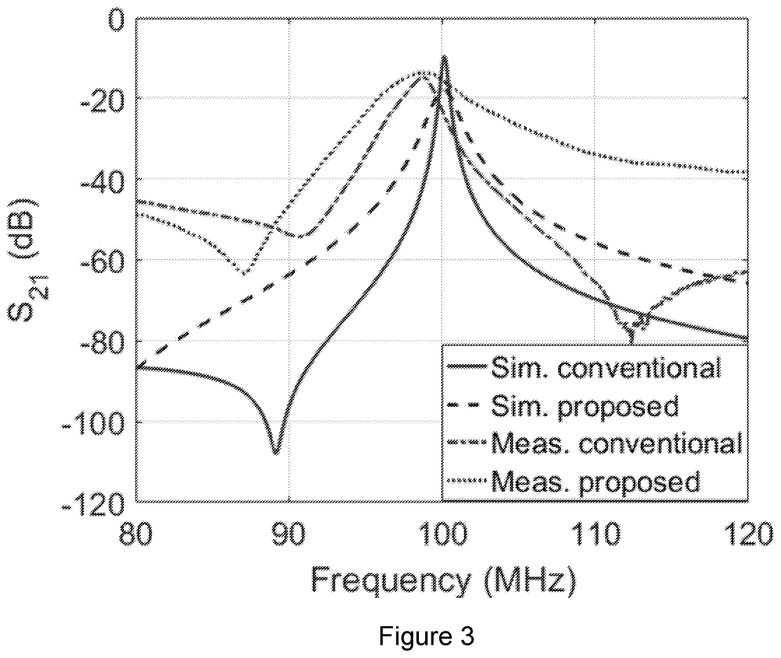

FIG. 3 shows the simulated transmission coefficients (S₂₁) of the two systems 100, 200. The simulation results show that system 100 has a −20 dB bandwidth of 1.2 MHz while the conventional system 200 has a bandwidth of 0.6 MHz. That is, an increase of 100% in bandwidth was found for the system 100 compared to conventional system 200.

### Electric Circuit Model and Analysis

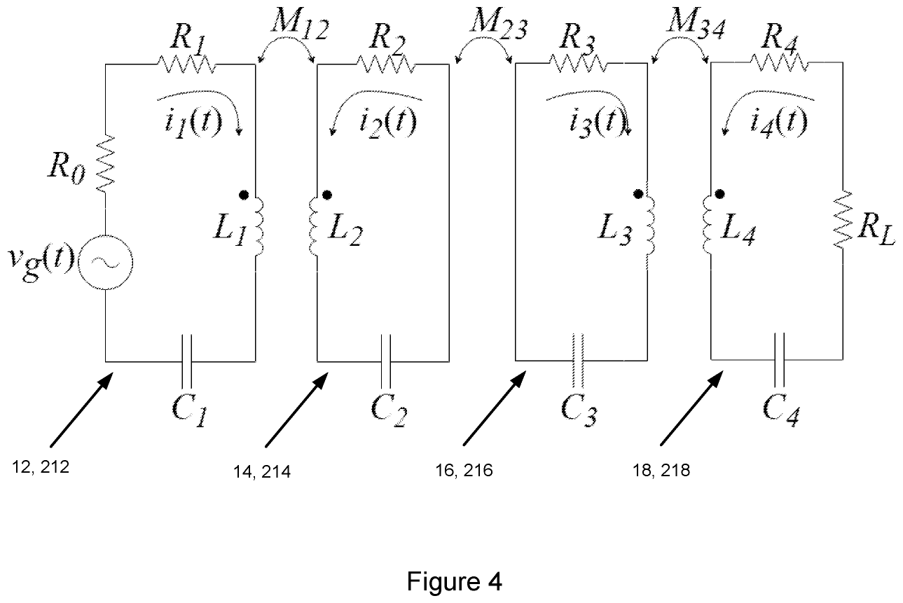

An equivalent circuit model of an example of system 100, and of conventional system 200, is shown in FIG. 4. The circuit as shown in FIG. 4, from left to right, shows coil 1 as transmit coil 12, 212, coil 2 as transmit resonant coil 14, 214, coil 3 as receive resonant coil 16, 216 and coil 4 as receive coil 18, 218. The resistance, R₁, R₂, R₃, R₄, inductance L₁, L₂, L₃, L₄, and capacitance C₁, C₂, C₃, C₄, of the respective coils are shown on FIG. 4. M₁₂ depicts the mutual inductance between L₁ and L₂ and M₃₄ depicts the mutual inductance between L₃ and L₄. A resonance coupling is modelled as mutual inductance M₂₃ and can be observed between transmit resonant coil 14, 214 and receive resonant coil 16, 216.

Changing the position of transmit coil 12, 212 relative to transmit resonant coil 14, 214 may change the mutual inductance M₁₂. Similarly, mutual inductance of M₃₄ may change when the position of receive coil 18, 218 is changed relative to receive resonant coil 16, 216.

In this example circuit, a power source ν_{g} with an internal resistance R₀ is connected to transmit coil 12, 212 as shown in FIG. 4. The receive coil 18, 218 is connected to a load R_{L}. When the circuit is connected and a power source applied, current flows within the circuit, denoted as i₁ to i₄, respectively.

For the purposes of this analysis, the couplings between non-successive coils, e.g. transmit coil 12, 212 and receive resonant coil 16, 216, are assumed to be negligible as they are typically much weaker than that of the successive coils, e.g. transmit coil 12, 212 and transmit resonant coil 14, 214.

The mutual inductance, Mᵢⱼ, between two inductors Lᵢ and Lⱼ may be expressed using coupling factors as shown in the equation below,

Mᵢⱼ=kᵢⱼ\sqrt{LᵢLⱼ} (1)

Impedance, Z, for each circuit can be defined as:

$${Z}_{1} ( ω ) = {R}_{0} + {R}_{1} + j ω {L}_{1} + \frac{1}{j ω {C}_{1}}$$

$${Z}_{2} ( ω ) = {R}_{2} + j ω {L}_{2} + \frac{1}{j ω {C}_{2}}$$

$${Z}_{3} ( ω ) = {R}_{3} + j ω {L}_{3} + \frac{1}{j ω {C}_{3}}$$

$${Z}_{4} ( ω ) = {R}_{L} + {R}_{4} + j ω {L}_{4} + \frac{1}{j ω {C}_{4}} .$$

Applying Kirchoff's voltage law, the voltage for each loop can be written as equations below:

V_{g}(ω)=Z₁(ω)I₁(ω)+jωM₁₂I₂(ω) (2)

0=Z₂(ω)I₂(ω)+jωM₁₂I₁(ω)+jωM₂₃I₃(ω) (3)

0=Z₃(ω)I₃(ω)+jωM₂₃I₂(ω)+jωM₃₄I₄(ω) (4)

0=Z₄(ω)I₄(ω)+jωM₃₄I₃(ω) (5)

Where V_{g}(ω), I₁(ω), I₂(ω), I₃(ω) and I₄(ω) are corresponding phasors of ν_{g}(t), i₁(t), i₂(t), i₃(t), and i₄(t), respectively. Solving equations (2)-(5) above, the currents can be expressed using V_{g}(ω) and the impedance of loops, as shown in the equations below:

$$\begin{matrix}{I}_{1} ( ω ) = \frac{B ( ω ) \cdot {V}_{g} ( ω )}{A ( ω )} & ( 6 ) \\ {I}_{4} ( ω ) = \frac{- j {ω}^{3} {M}_{12} {M}_{23} {M}_{34} {V}_{g} ( ω )}{A ( ω )} & ( 7 )\end{matrix}$$

where A(ω)=ω²M²₁₂Z₃(ω)Z₄(ω)+ω²M²₂₃Z₁(ω)Z₄(ω)+ω²M²₃₄Z₁(ω)Z₂(ω)+Z₁(ω)Z₂(ω)Z₃(ω)Z₄(ω)+ω⁴M²₁₂M²₃₄; and
B(ω)=ω²M²₂₃Z₄(ω)+ω²M²₃₄Z₂(ω)+Z₂(ω)Z₃(ω)Z₄(ω).

The power transfer efficiency, η, may be defined as the ratio of the power consumed on the load R_{L} and the input power as shown below:

$$η ( ω ) = \frac{{P}_{L} ( ω )}{{P}_{in} ( ω )} = \frac{\frac{1}{2} {\vert {I}_{4} ( ω ) \vert}^{2} {R}_{L}}{\frac{1}{2} Re \{ {V}_{g} ( ω ) {I}_{1}^{*} ( ω ) \}} = \frac{{ω}^{6} {M}_{12}^{2} {M}_{23}^{2} {M}_{34}^{2} {R}_{L}}{Re \{ A ( ω ) {B}^{*} ( ω ) \}} \qquad ( 8 )$$

Advantageously, by placing transmit coil 12 at the centre of transmit resonant coil 14 and receive coil 16 at the centre of receive resonant coil 16 as shown in FIG. 1, the leakage of magnetic flux can be suppressed. This may result in an enhancement of mutual inductance M₁₂ and M₃₄ compared to the conventional system 200 as shown in FIG. 2.

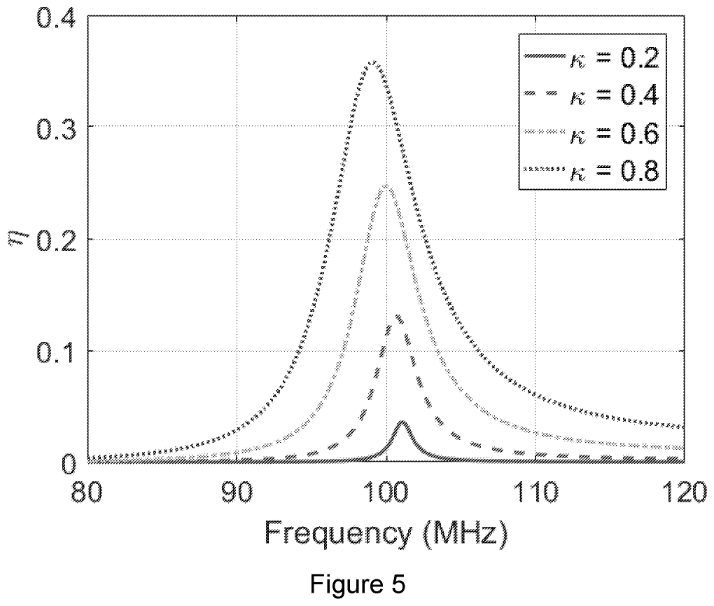

Since the distance between transmit resonant coil 14, 214 and receive resonant coil 16, 216 for system 100 and system 200 are unchanged, mutual inductance M₂₃ should remain substantially the same between the two systems. In this example, the parasitic parameters (R, L and C) of each coil do not vary. The values of parasitic parameters of the coils can be extracted by using software such as ANSYS Q3D Extractor. In this example, the resistance of both R₀ and R_{L}is 50Ω. In this example, the parameters from this example can be used in Equation (8) which allows the numerical relationship between efficiency η and the mutual inductance M₁₂ and M₃₄ to be obtained. Assuming the system is symmetric, we can define the coupling coefficient, κ=κ₁₂=κ₃₄. FIG. 5 shows the numerical relations between η and κ for this example. The 3 dB bandwidths (η≥½ηₘₐₓ) are extracted from FIG. 5 and shown in the table below:

THE −3 dB BANDWIDTH OF THE SYSTEM WITH DIHERENT κ

| | | | | |
|---|---|---|---|---|
| κ | 0.2 | 0.4 | 0.6 | 0.8 |
| −3 dB BW (MHz) | 1.6 | 3.4 | 5.2 | 7.4 |

The table above shows that the bandwidth of the system increases as κ increases. For example, the 3 dB bandwidth doubles when κ increases from 0.2 to 0.4. Therefore, this analysis demonstrates that in this example, increasing mutual inductance e.g. M₁₂ and M₃₄, may result in an improved bandwidth of system 100 compared to conventional system 200. Advantageously, M₁₂ and M₃₄ of system 100 may be increased, thereby increasing the bandwidth of system 100, compared to conventional system 200, by placing transmit coil 12 and receive coil 18 at the centre of respective resonant coils 14, 16.

### Experimental Validation of System 100

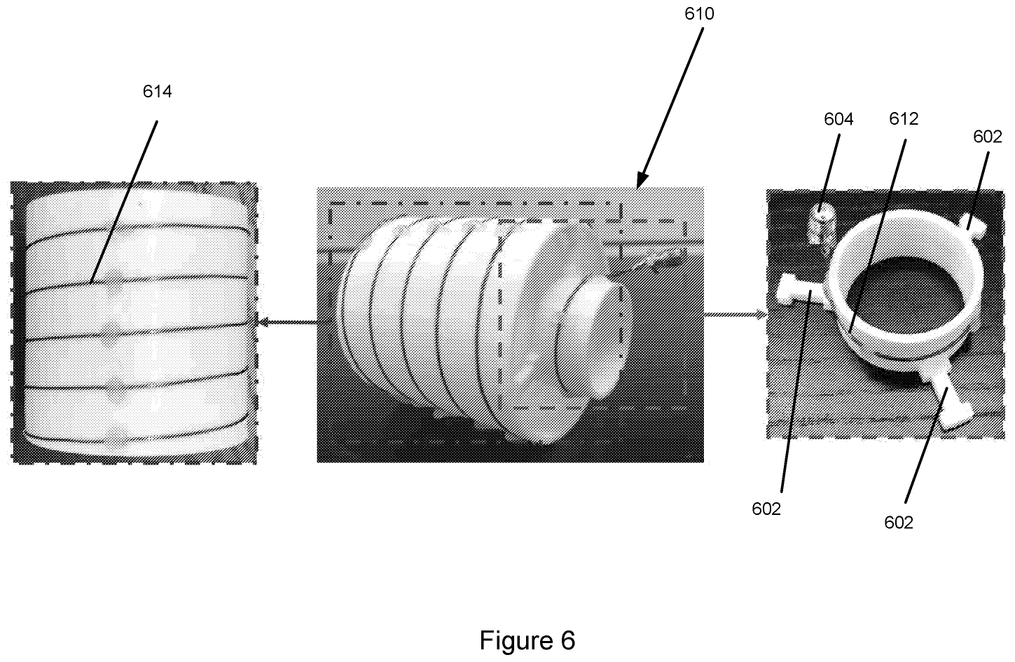

An example of an experimental configuration 610 for comparing system 100 to conventional system 200 is shown in FIG. 6. In this example, the coils were built by winding copper wire around a 3D printed support 620 as shown in FIG. 6. Preferably, the 3D printed supports 620 include grooves on the surface for increasing the accuracy of placement of the wires when the coils are wound around the support. Of course, the support 620 may be made from any other fabrication methods and is not limited to 3D printed fabrication.

The model system 610 includes a transmit resonant coil 614 wound around the 3D printed support 620. A secondary support member 622 is mountable within the support 620 for sliding movement along an axis of the support 620. A transmit coil 612 is wound around the secondary support member 622. The secondary support member 622 may be located at one end of the support 620, and thus of transmit resonant coil 614, in which case the model system 610 is analogous to a conventional transmitter 200. The secondary support member 622 may be moved within the support 620 so that the transmit coil 612 is located within transmit resonant coil, in which case the model system 610 is analogous to the transmitter 100 of FIG. 1. A similar or substantially identical model system (not shown) can be employed as a receiver.

The dimensions of the coils in FIG. 6 are similar to those in the verification model simulation i.e. radius of the resonant coils 614; R=40 mm, radius of the transmit and receive coils 612, r=20 mm; distance between the centre of the transmit resonant coil and receive resonant coil, D=400 mm; radius of the wire, r_{w}=0.5 mm; spacing between the transmit coil and the receive coil and their corresponding resonant coils, s=5 mm. Of course, other dimensions may be used in other configurations.

In this example, the support 622 for transmit and receive coils 612 includes support arms 602 for coupling with the inner surface of the support 620 of resonant coils 614. In some embodiments, the support arms 602 are coupled to the inner surface of the support of resonant coils 614 by means of a fastener such as adhesive tape for selectively uncoupling the arms 602. Advantageously, the inner surface of the support 620 of resonant coils 614 and the corresponding surface of the support arms 602 are sufficiently smooth for allowing the support arms 602 to slide along the inner surface of the support 620 to be repositioned within the support or removed from the support. For this example, the secondary support member 622 is configured to be uncoupled from the support 620 and repositioned which allows the testing of system 100 and conventional system 200 to be conducted.

For example, a vector network analyser (VNA) from Rhode & Schwarz (ZVH 8) can be used to measure the transmission coefficient, S₂₁, for system 100 and conventional system 200. Coaxial cables, for example 1.5 m, Junflon MWX 221, may be used to couple transmit coils to port 1 of the VNA via connection point 604 and receive coils to port 2 of the VNA.

The measured S₂₁ values from system 100 (i.e. Meas. proposed) and conventional system 200 (i.e. Meas. conventional) for this example are shown in dotted lines in FIG. 3. This example shows that at resonant frequency 100.1 MHz, the measured 20 dB bandwidth of the system 100 is 5.6 MHz compared to that of the conventional system being 2.4 MHz. Advantageously, an increase in bandwidth of 133% is achieved for system 100 compared to conventional system 200 in this example.

Advantageously, by placing the transmit and receive coils within the corresponding resonators, the gain in the bandwidth does not cause a compromise in gain in the measurement.

Some differences between the simulated and measured results as shown in FIG. 3 may be due to factors such as fabrication error of the coil, surrounding interference and the limited measurement accuracy of the VNA.

Advantageously, the system 100 provides an increased bandwidth by placing the transmitter coil 12 at the centre of the resonator 14 and receiver coil 18 at the centre of resonator 16. An increased bandwidth, also known as a wideband feature, is advantageous especially when the efficiency of a WPT is low due to a drift in resonant frequency.

### Resonant Coil Design

### Shape of the Helix

In some embodiments, the shape of the resonant coils may affect the transmission efficiency. For example, a shape of a resonant coil which may be advantageous for better transmission efficiency is an ellipsoidal helical resonator. Specifically, a type of ellipsoidal helix is a spherical helix, also known as “flux-ball” and advantageously provides homogenous magnetic field within the helix. In some embodiments, a helix such as a spherical helical antenna demonstrates circular polarization over a wide bandwidth when it is electrically fed directly.

To demonstrate the efficacy of helical coils for use as resonant coils in system 100, various helical resonant coils were tested by computer simulation, for example by using COMSOL Multiphysics®, and experimental setups. In particular, the performance of the coils was assessed by measuring the efficiency and wideband characteristics. Of note, the sensitivity to alignment of the various shapes of coils was also investigated.

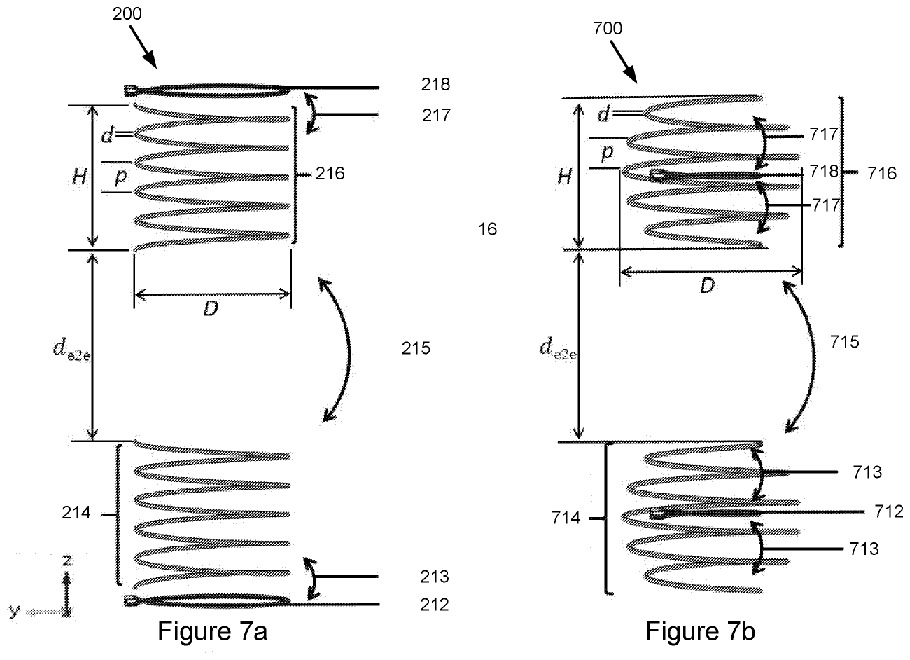

FIG. 7a shows a conventional system 200 with transmit resonant coil 214 and receive resonant coil 216 that has a cylindrical helix shape (i.e. a solenoid). Transmit coil 212 is placed outside transmit resonant coil 214 and receive coil 218 is placed outside receive resonant coil 216 as shown in FIG. 7a. The axial length, diameter, and pitch of the helix are denoted using H, D, and p, respectively. The diameter of the wire is denoted by d.

A helix has an intrinsic resonant frequency (fᵣ) which may be determined by its intrinsic inductance and capacitance, Lᵢ and Cᵢ as shown below:

$${f}_{r} = \frac{1}{2 π \sqrt{{L}_{i} {C}_{i}}}$$

The quality factor, Q, of a helix may be calculated using the following equation:

$$Q = \frac{2 π {f}_{r} {L}_{i}}{{R}_{i}}$$

The intrinsic resistance of the helix, Rᵢ, may be calculated as follows:

Rᵢ=Rₒₕₘ+R_{rad}
where Rₒₕₘ is the ohmic resistance and R_{rad} is the radiation resistance.

Typically, the intrinsic inductance, capacitance and resistance of a helix is dependent on the structure of the helix. The intrinsic inductance of a short cylindrical helix (e.g. D>H) filled with air can be approximated as follows:

$${L}_{i} = {μ}_{0} {rN}^{2} [ ln ( \frac{8 r}{H} ) - 2 ]$$

where μ₀ is the permeability of vacuum, N is the number of turns of the coil, r is the radius of the coil, r=D/2.

The inductance of a long helix (e.g. D<<H) can be calculated using modified Nagaoka coefficients as follows:

Lᵢ=μ₀N²πr²/H

The Rₒₕₘ and R_{rad} of a helix coil can be calculated using:

$${R}_{ohm} = ( \sqrt{\frac{π {f}_{r} {μ}_{0} ρ}{σ}} ) N r \text{/} {r}_{w}$$

$${R}_{rad} = ( \frac{π}{6} ) {η}_{0} {{N}^{2} ( \frac{2 π {f}_{r} r}{c} )}^{4}$$

where ρ is the resistivity and σ is the conductivity of the material of the wire, r_{w} is the radius of the wire (r_{w}=d/2), η₀ is the wave impedance in free space, and c is speed of light in vacuum.

The intrinsic capacitance of coil can be calculated using:

$${C}_{i} = \frac{2 {π}^{2} r {ɛ}_{0}}{ln [ \frac{p}{2 {r}_{w}} + \sqrt{{[ \frac{p}{2 {r}_{w}} ]}^{2} - 1} ]}$$

where ε₀ is the permittivity of vacuum.

The equations above provide some insight on which parameters may affect the working bandwidth of a cylindrical helix. The working bandwidth, which is related to fᵣ and Q, are dependent on the radius of loop (r), radius of wire (r_{w}), axial length (H) and the pitch between two adjacent loops (p).

A high Lᵢ and Cᵢ correspond to a low resonant frequency, which may mean that a low resonant frequency may result from a larger radius of the helix, smaller number of turns, shorter axial lengths, smaller pitch, and larger radius of the wire.

Further, a high Lᵢ and a small Rᵢ may lead to a high Q factor which may result from smaller axial length, larger radius of wire, and smaller number of turns.

Importantly, when the outline of a cylindrical helix is changed to a sphere, the intrinsic impedance of the resultant spherical helix may be changed. For example, the inductance of a spherical helix is scaled down and reduced to:

Lᵢ≡(2/9)μ₀N²πr
where r is the radius of the spherical outline and N is the total number of turns.

FIG. 7b shows an example of system 700 where the receive and transmit resonant coils 714, 716 are ellipsoidal helical coils. Preferably, the transmit coil 712 and receive coil 718 are positioned substantially centrally along the length of the receive and transmit resonant coils 714, 716 respectively. Advantageously, system 700 provides a wide bandwidth while maintaining high efficiency, for potential applications such as for use in human involved environments.

In this example, the coils 714, 716 are tapered from the middle of the coil to the ends in the axial direction which forms an ellipsoidal surface which may be described by the parametric equations below:

x(t)=R·A(t)·cos(t)

y(t)=R·A(t)·sin(t)

z(t)=R·\sqrt{1−A²(t)}
where t is a parametric variable ranging from −nπ to nπ (n is the number of turns of the coil), A(t) is the tapering function that defines how the helix tapers along the axial direction from a radius of R at the middle to zero at the two extreme ends.

For example, in order to form an ellipsoidal shape, t∈[−6π, 6π] and the tapering function A(t) should satisfy the following conditions:
1) A(−6π)=A(6π)=0
2) A(0)=1
3) A(t) is an even function, and is continuous on [−6π, 6π]

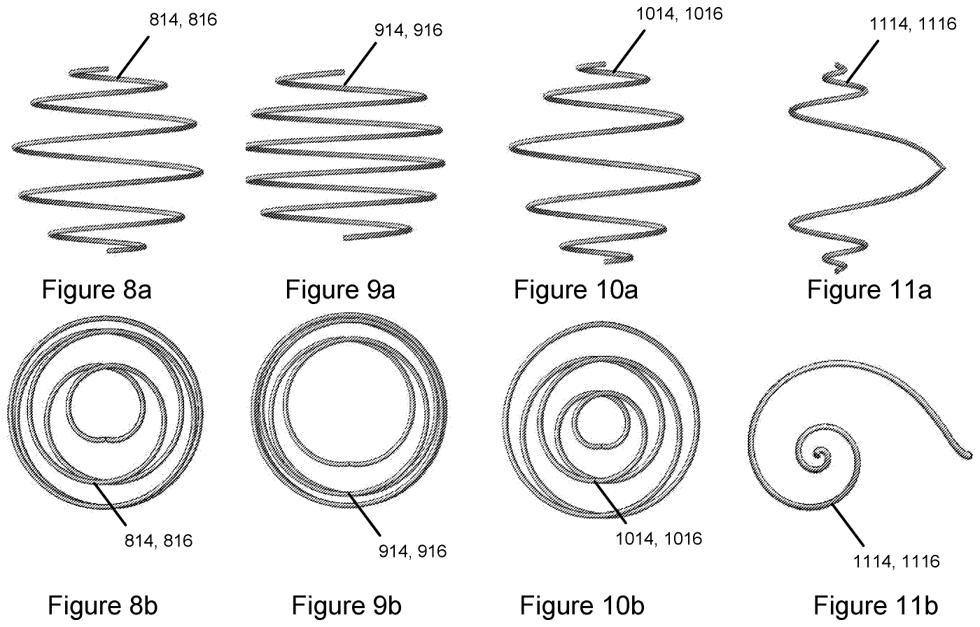

Further examples of tapering functions for ellipsoidal shapes for ellipsoidal helix coils 714, 716 of system 700 include:

| | | Figure | |
|---|---|---|---|
| | Figure | showing | |
| Shape of | showing | transversal | Tapering function, |
| outline | side view | view | A(t) |
| Sinusoidal helix | FIG. 8a | FIG. 8b | cos(t/N) |
| 814, 816 | | | |
| Circular helix | FIG. 9a | FIG. 9b | √1 − (t/6π)² |
| 914, 916 | | | |
| Linear helix | FIG. 10a | FIG. 10b | 1 − sign (t) · t/6π) |
| 1014, 1016 | | | |
| Concave helix | FIG. 11a | FIG. 11b | 1 − √1 − (t/6π) − sign(t))² |
| 1114, 1116 | | | |

FIGS. 8a and 10a show the structure of the sinusoidal helix 814, 816 and linear helix 1014, 1016 and the shape appears to be substantially elliptical. FIG. 9a shows the structure of the circular helix 914, 916 and the shape appears to be substantially circular. FIG. 11a shows the structure of the concave helix 1114, 1116 and the shape has an outline like a flying saucer.

For the sinusoidal helix 814, 816, a value of N=12 may be chosen for making a nearly complete elliptical outline. For the linear helix 1014, 1016 and concave helix 1114, 1116, sign(t) may be defined as a function extracting sign of t as follows:

$$sign ( t ) = \{ \begin{matrix}- 1 & t < 0 \\ 0 & t = 0 \\ 1 & t > 0\end{matrix}$$

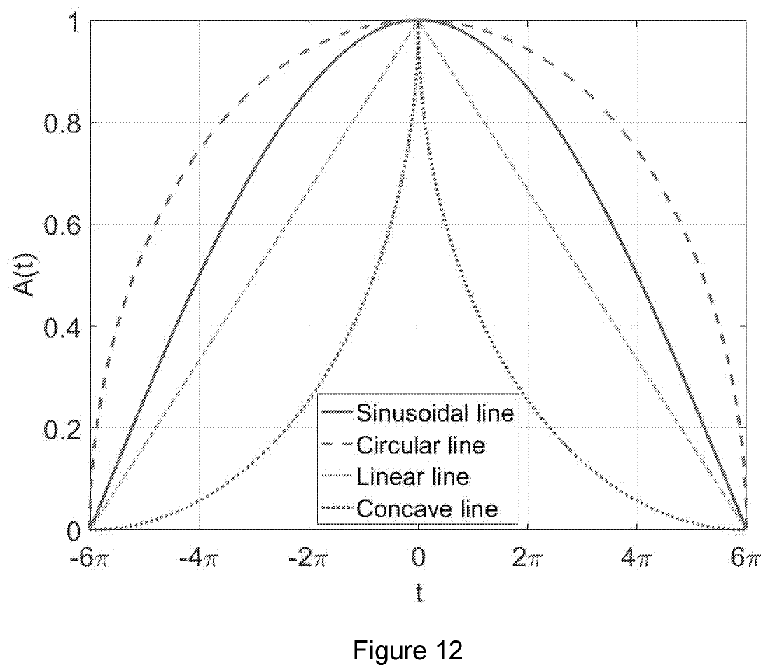

For example, FIG. 12 shows plot of the tapering functions of the four helix shapes provided above versus a function of time (t). FIG. 12 shows that of the four helix shapes, for the tapering function A(t) when plotted against time, the concave helix 1114, 1116 tapers the most from t=0 towards [−6π, 6π] followed by the linear helix 1014, 1016, the sinusoidal helix 814, 816 and finally the circular helix 914, 916.

Preferably, the transmit and receive coils 712, 718 of system 700 are placed at the centre of the corresponding resonant coils 714, 716 as shown in FIG. 7b. Advantageously, this maximises the coupling between the transmit coil 712 and the receive coil 718 by minimizing leakage of flux during the coupling as the magnetic flux generated from the transmit coil 712 flows through resonant coils 714 and 716. Advantageously, system 700 with elliptical helix transmit resonant coil 714 and elliptical helix receive resonant coil 716 have performed impedance matching using lumped elements at the transmit coil 712 and receive coil 718 for maximizing the power transfer efficiency at the resonant frequency, fᵣ, of the resonant coils. For example, impedance matching is performed by using one capacitor in series and another in shunt.

The performance of the coils can be estimated by considering the transmit coil 712 and transmit resonant coil 714 to be an induction excited antenna i.e. when power is fed to the transmit coil 712, the resonator is inductively excited. For example, an electrically small antenna may be defined when the dimension of the antenna is much smaller than that of its working wavelength i.e. ka<1, where k is the wavenumber, and a is the maximal dimension of the antenna. The quality factor of an electrically small antenna may be estimated where the lower bound of Q factor can be estimated using the equation below:

$${Q}_{lb} = \frac{1}{{( ka )}^{3}} + \frac{1}{ka}$$

In some examples, electrically small sized resonant coils have high Q factors. However, by optimising the coil design, a lower bound of Q may be achieved. For example, the Q factor may be decreased if a volume, for example defined by a sphere, surrounding the electrically small antenna is fully utilized.

For example, the coil's quality factor, Q, and effective volume is related by:

$$r = \frac{λ}{2 π} {( \frac{9}{2 Q} )}^{\frac{1}{3}}$$

where r is the radius of a sphere defining the effective volume of the coil.

According to the equation above, coils occupying a larger effective volume may have a lower Q factor thereby achieving a wider bandwidth. Coils with a spherical shape would occupy more effective volume compared to a cylindrical shape, for example, therefore coils with a spherical shape typically have lower Q factors.

Simulations of ellipsoidal helix coils and a conventional cylindrical helix coil (e.g. resonant coils 216, 214 as shown in FIG. 7a) were conducted to estimate the corresponding Q factors as listed below:

Q FACTOR OF THE PROPOSED COILS

| Coil | Q factor |
|---|---|
| Cylindrical helix | 1884.3 |
| Circular outline | 1326.8 |
| Sinusoidal outline | 509.9 |
| Linear outline | 544.4 |

The simulations were performed using CST Microwave Studio, for example. The simulations show that the sinusoidal helical coil has the lowest Q factor amongst the four coil designs where the cylindrical helix has the highest Q factor. This indicates that the sinusoidal helix system 800 has the widest bandwidth compared to the circular helix system 900, linear helix system 1000 and concave helix system 1100.

To evaluate the performance of the system 700, power transmission efficiency, η_{T}, can be used as shown below:

$${η}_{T} = \frac{{\vert {S}_{21} \vert}^{2}}{1 - {\vert {S}_{11} \vert}^{2}}$$

where S₂₁ and S₁₁ are the transmission and reflection coefficients, respectively, of a two port network system.

In some examples, the power transmission efficiency, η_{T}, can be defined as the ratio of the power delivered to the load and that delivered to the input of the system from the source. This is different compared to a system energy efficiency that quantifies the ratio of the power to the load and that from the source which may result in a lower power transmission efficiency.

Simulations of the four ellipsoidal resonant coils as shown in FIGS. 8a, 9a, 10a and 11a and a conventional cylindrical helix coil as shown in FIG. 7a were performed using an eigenfrequency simulation, such as COMSOL Multiphysics®. In this example, the maximal dimensions of all the resonant coils were set to the same value i.e. D=180 mm.

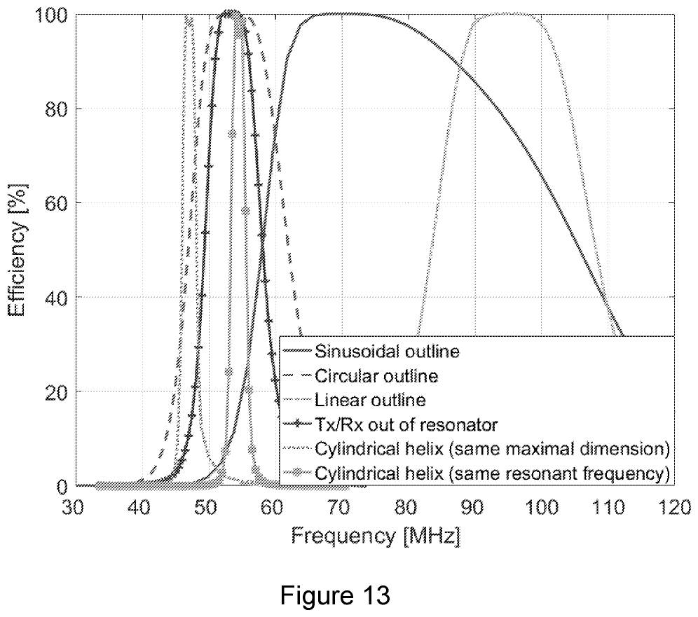

The conventional cylindrical helix system 200 as shown in FIG. 7a and ellipsoidal helix system 700, with the four ellipsoidal resonant coils as shown in FIGS. 8a, 9a, 10a and 11a, were simulated using a frequency domain solver. In this example, the edge-to-edge distance, dₑ₂ₑ, between two resonators as shown in FIGS. 7a and 7b was set to be 20 cm. In this exemplary simulation, impedance matching was done at both ports by adding lumped elements and perfectly matched layer was set to be the boundary condition. FIG. 13 shows the calculated transmission efficiency of these systems. In this example, the concave helix system 1100 did not achieve a high efficiency and as such, was omitted from FIG. 13.

The table below itemises the 90%-efficiency-BW's of the simulated systems:

SIMULATED SELF RESONANT FREQUENCY AND BANDWIDTH
(BW) OF THE RESONATORS

| | Sinusoidal | Circular | Linear | Concave | Cylindrical helix | Cylindrical helix |
|---|---|---|---|---|---|---|
| Outline shape | outline | outline | outline | outline | (same D) | (same fᵣ) |
| fᵣ [MHz] | 69.75 | 53.45 | 94.61 | 212.34 | 47.10 | 53.45 |
| 90%-efficiency-BW | 35.84% | 14.97% | 13.74% | \ | 2.3% | 2.6% |

Simulation results above demonstrate that the shape of the coils affect both the resonant frequency and the bandwidth of the exemplary systems. For example, the linear helix system 1000 has the highest fᵣ of the systems that were simulated in this example and it tapers the most whereas the spherical helix system 900 has the lowest fᵣ and it tapers the least. The sinusoidal helix system 800 shows the maximum bandwidth, for example. In this example, the ellipsoidal systems appear to outperform the cylindrical helix system 200, demonstrating that for the bandwidth and the resonant frequency of the coils may be increased by tapering the shape of the coil whilst not compromising the inband efficiency. Further, it appears that the extent of tapering of the shape of the coil shifts the resonant frequency of a helical resonant coil higher. This may be because the tapering the outline of a helix reduces its intrinsic inductance and capacitance. It also appears that a tapered structure, such as a sinusoidal helix, favours a wide bandwidth.

Another example of a cylindrical helix system 200 includes a decreased the size of the cylindrical helix set to resonate at the same resonant frequency as the spherical helix system 900 i.e. 53.45 MHz. As shown in FIG. 13, the line indicated as cylindrical helix (same resonant frequency), the spherical helical system 900 shows a 90%-efficiency-BW of 15.0%, which is much wider compared to 2.6% of the cylindrical helical system. In terms of the inband efficiency, for example, the spherical helical system 900 is comparable with the cylindrical system as simulated.

The effect of placement of the transmit and receive coils were examined by simulating the system with the transmit and receive coils placed 30 mm away from the edge of the respective resonant coils, for example the resonant coils have cylindrical helix shapes. This simulation demonstrates that when the transmit and receive coils were moved out of the resonator, the bandwidth was reduced which in turn may lower the inband efficiency, although it does not affect the resonant frequency of the system.

From the simulated results of the systems above, the spherical helical system 900, or circular outline system, has a resonant frequency, fᵣ, that is similar to the cylindrical helical system 200 i.e. difference is 6.15 MHz between the two systems. To analyse the difference between the systems, the magnetic field distributions of these two systems were examined. For example, signals of 1V were applied at the resonant frequency to the transmit coil i.e. 47.51 MHz for the cylindrical helical system 200 and 53.45 MHz for the spherical helical system 900 and at an off-resonant frequency i.e. 60.51 MHz for the cylindrical helical system 200 40.95 MHz for the spherical helical system 900.

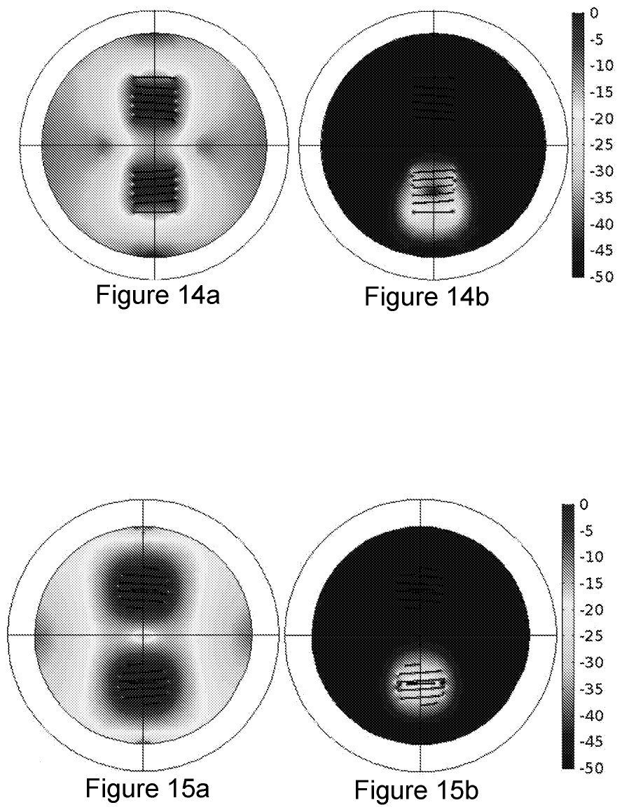

FIGS. 14a and 14b show the simulated magnetic field distribution (20 log₁₀|H|) in resonant and off-resonant states respectively of the cylindrical helical system 200. FIGS. 15a and 15b show the simulated magnetic field distribution (20 log₁₀|H|) in resonant and off-resonant states respectively of the spherical helical system 700. The simulated magnetic field distribution appears to demonstrate that power is transferred more efficiently at resonance compared to the off-resonant frequency. The results from this exemplary simulation demonstrates that the spherical helical system 700 experiences a higher field intensity at the receive side compared to cylindrical helical system 200. It appears that there may be higher power transfer efficiency at the resonance frequency for the system 700. The spherical helical system 700 also appears to have more spread out energy compared to the cylindrical helical system 200 indicating that the spherical helical system 700 may have a lower misalignment sensitivity of the transmit and receive coils.

The simulation studies above have shown that ellipsoidal helical system 700 may have a wider bandwidth than a cylindrical helical system 200. This may be achieved even when the systems have the same maximal dimension or the same resonant frequency whilst keeping a comparable efficiency. Of note, it appears that the sinusoidal helix system 800 may have a wide bandwidth, compared to the other example systems discussed above. It appears that the tapering of the outline of a helix may widen the bandwidth of the helix system 700. The placement of transmit and receive coils with respect to the resonant coils also appear to contribute to a broadband performance.

### Deformation of a Sinusoidal Helix in the Axial Direction

A helix may be deformed along the axial direction. The performance of wireless power systems using helix coils such as sinusoidal helical resonant coils 814, 816 may be affected by the deformation of the helix coil in the axial direction and as such, simulations were performed to investigate this effect. For example, the maximum pitch of a sinusoidal helical coil can be fixed whilst varying the axial length to determine the effect of deformation of a sinusoidal helix in the axial direction.

For example, a sinusoidal helical coil may be expressed by parametric equations below:

x(t)=βₓR cos(t/N)cos(t)

y(t)=β_{y}R cos(t/N)sin(t)

z(t)=αR sin(t/N)
where βₓ and β_{y} are the scaling coefficients along the transversal direction, and α is the scaling coefficient in the axial direction. Without scaling, βₓ=β_{y}=α=1.

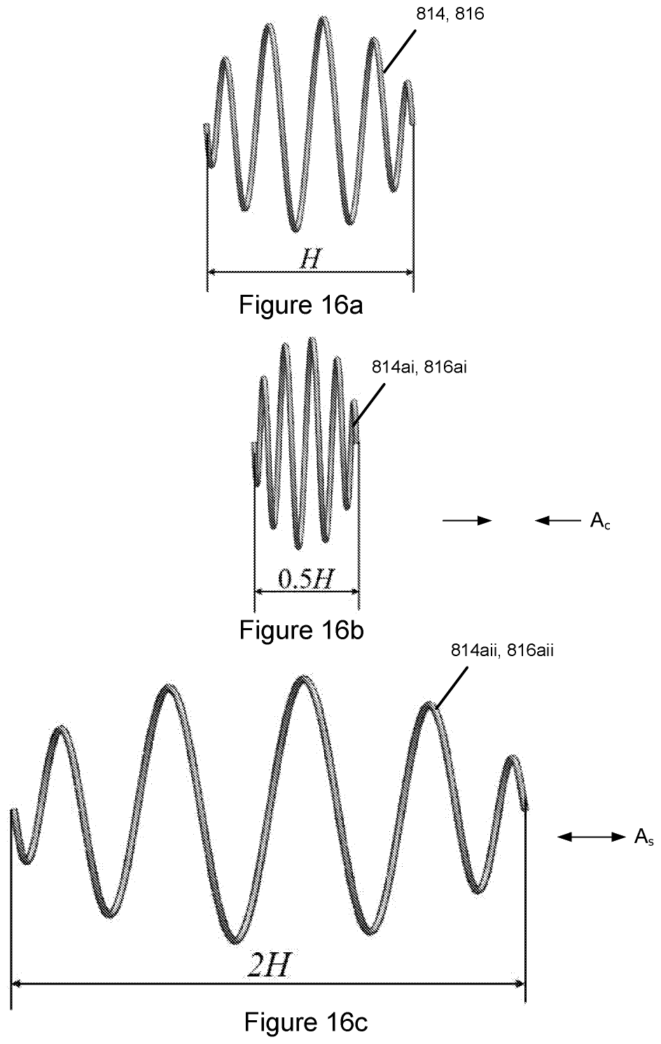

A scaling coefficient in the axial direction can be applied to achieve an axially compressed sinusoidal helix 814ai, 816ai, e.g. α=0.5 H (i.e. compression in direction of A_{c}), as shown in FIG. 16b or an axially stretched sinusoidal helix 814aii, 816aii e.g. α=2 H (i.e. direction of Aₛ), as shown in FIG. 16c as compared to the normal sinusoidal helix 814, 816 e.g. α=H, as shown in FIG. 16a.

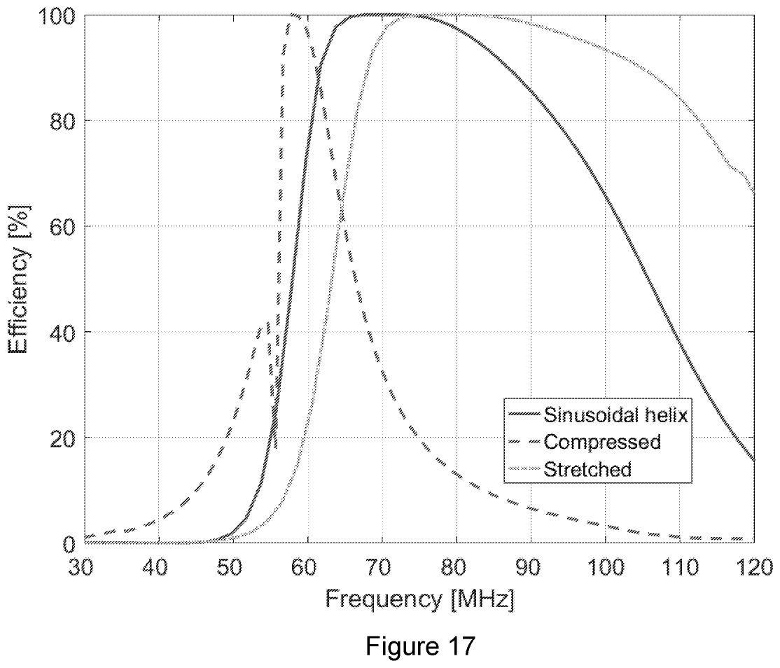

Simulations similar to that conducted in the previous section were conducted to determine the effect of axial scaling on the resonance and bandwidth of sinusoidal helical system 900. The simulations results for these examples are in FIG. 17 and itemised below:

SIMULATED SELF RESONANT FREQUENCY AND BANDWIDTH
OF AXIAL-MODIFIED SINUSOIDAL HELICES

| Axial Scaling | Sinusoidal | Compressed | Stretched |
|---|---|---|---|
| fᵣ [MHz] | 69.75 | 57.68 | 78.61 |
| 90%-efficiency-BW | 35.84% | 8.67% | 47.07% |

The results above demonstrate that the axially compressed sinusoidal helix 814ai, 816ai may have a decreased fᵣ by around 17.3% and a decreased 90%-efficiency-BW by around 75.8% compared to the normal sinusoidal helix 814, 816. In contrast, the axially stretched sinusoidal helix 814aii, 816aii may show an increased fᵣ by around 12.7% and an increased 90%-efficiency-BW by around 31.3%.

The Q factors from exemplary simulations of the axially compressed sinusoidal helix 814ai, 816ai, normal sinusoidal helix 814, 816 and axially stretched sinusoidal helix 814aii, 816aii are itemised below:

Q FACTOR OF THE AXIAL SCALED COILS

| Coil | Q factor |
|---|---|
| Compressed sinusoidal helix | 1914.3 |
| Sinusoidal helix | 509.9 |
| Stretched sinusoidal helix | 157.9 |

The results above demonstrate that increasing the scaling coefficient in the axial direction, α, may contribute to a wider bandwidth.

In some systems, a longer axial length may lead to smaller inductance, and a higher resonant frequency. A longer axial length may also contribute to a lower Q factor of the coil, which may correspond to a wider bandwidth of a wireless power transfer system. In other words, a wider bandwidth may come with a higher resonant frequency at a price of an increase in the physical size in the axial direction.

### Deformation of a Sinusoidal Helix in the Transverse Direction

A helix may be deformed along the transverse (or transversal) direction. The performance of wireless power systems using helix coils such as sinusoidal helical resonant coils 814, 816 may be affected by the deformation of the helix coil in the transverse direction and as such, simulations were performed to investigate this effect. For example, the axial length of a sinusoidal helical coil can be fixed whilst varying the maximum pitch to determine the effect of deformation of a sinusoidal helix in the transverse direction.

For example, a sinusoidal helical coil may be expressed by parametric equations below:

x(t)=βₓR cos(t/N)cos(t)

y(t)=β_{y}R cos(t/N)sin(t)

z(t)=αR sin(t/N)
where βₓ and β_{y} are the scaling coefficients along the transversal direction, and α is the scaling coefficient in the axial direction. Without scaling, βₓ=β_{y}=α=1.

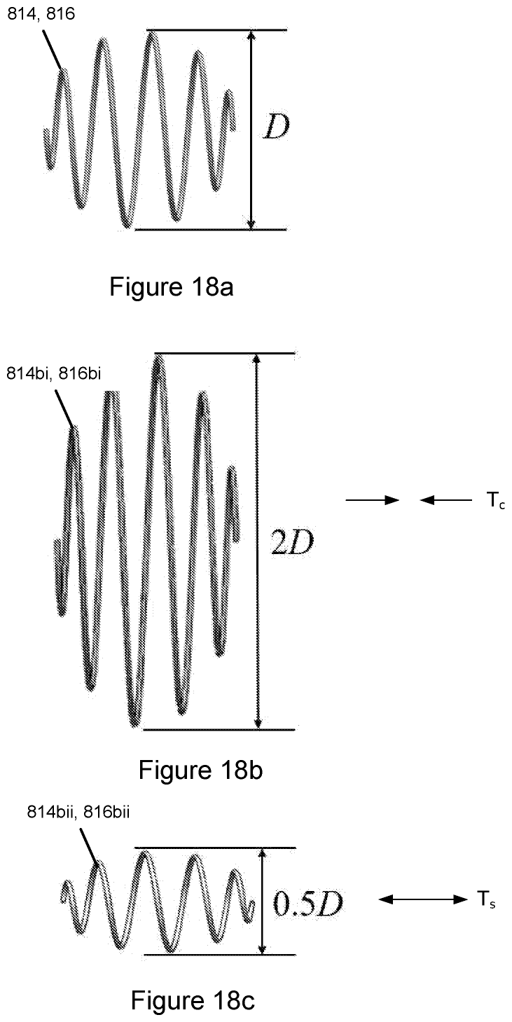

A scaling coefficient in the transverse direction can be applied to achieve a transversely compressed sinusoidal helix 814bi, 816bi, e.g. β=2 (i.e. direction of T_{c}), as shown in FIG. 18b or a transversely stretched sinusoidal helix 814bii, 816bii e.g. β=0.5 (i.e. direction of Tₛ), as shown in FIG. 18c as compared to the normal sinusoidal helix 814, 816 e.g. β=1, as shown in FIG. 18a.

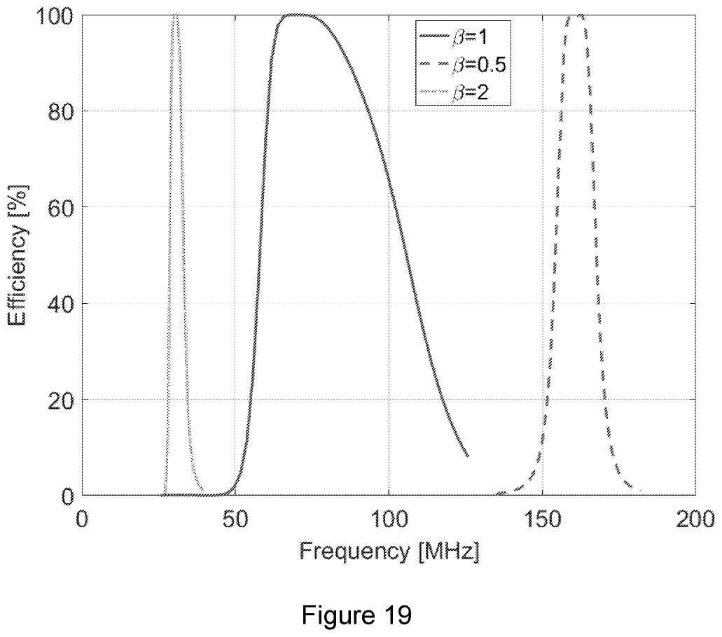

Simulations similar to that conducted in the previous section were conducted to determine the effect of transverse scaling on the resonance and bandwidth of sinusoidal helical system 900. The simulations results for these examples are in FIG. 19 and itemised below:

SIMULATED SELF RESONANT FREQUENCY AND BANDWIDTH
OF TRANSVERSAL-MODIFIED SINUSOIDAL HELICES

| Transversal scaling | β = 1 | β = 2 | β = 0.5 |
|---|---|---|---|
| fᵣ [MHz] | 69.75 | 29.80 | 160.85 |
| 90%-efficiency-BW | 35.84% | 9.06% | 5.03% |

It appears that a larger transversal scaling coefficient, i.e. a larger radius on the transversal plane, may contribute to a lower fᵣ e.g. for the case when β=2, fᵣ is around 29.80 MHz, which less than half compared to the case when β=1 where fᵣ is around 67.95 MHz. In addition, the normal sinusoidal helix 814, 816 (β=1) shows the maximal 90%-efficiency-BW of around 35.84%, compared the transversely stretched sinusoidal helix 814bii, 814bii (β=2) of 9.06% and the transversely compressed sinusoidal helix 814bi, 816bi of 5.03%.

In some systems, a larger radius on the transverse plane of a helix may lead to larger intrinsic inductance and larger capacitance which may result in a lower resonant frequency.

### Performance of Spherical Helical System 900

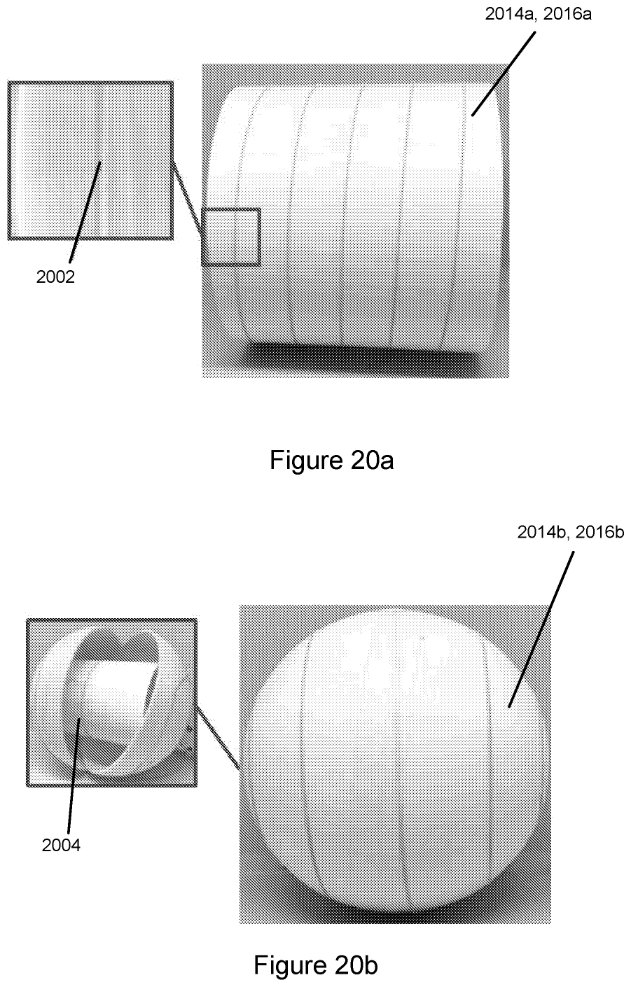

The performance of a spherical helical system 900 with a tapering function, A(t)={square root over (1−(t/6π)²))}, was tested by creating an exemplary spherical system 2000b as shown in FIG. 20b. For comparison, an exemplary cylindrical helical system 200 was also built as cylindrical system 2000a as shown in FIG. 20a. The support of these embodiments may be fabricated by a 3D printer. Advantageously, the supports include grooves on the surface for increasing the accuracy of placement of the wires when the coils are wound around the support as shown as grooves 2002 in FIG. 20a. In this example, a Litz wire was used with the following parameters DC current resistance=0.013 Ω/m, 0.48 Ω/m at 50 MHz to reduce resistive loss due to skin effect. The dimensions of the systems are shown in the table below (parameters as shown in FIGS. 7a and 7b):

THE DIMENSIONS OF THE TWO FABRICATED WPT SYSTEMS

| | Dimensions | Cylindrical system | Ellipsoidal system |
|---|---|---|---|
| Resonator | d (mm) | 1.2 | 1.2 |
| | N | 5 | 5 |
| | D (mm) | 180 | 180 |
| | H (mm) | 170 | 170 |
| | p (mm) | 34 | Not uniform |
| tx/rx loop | Wire radius (mm) | 0.6 | 0.6 |
| coil | Coil radius (mm) | 90 | 50 |

The maximal dimension, D, (i.e. the diameter of the cylindrical helical resonant coil 2014a, 2016a, and the diameter of the central loop of the spherical helical resonant coil 2014b, 2016b) of two systems were kept to be the same i.e. 180 mm.

The transmit and resonant coils were also built using the same Litz wire as the resonant coils and were housed within a 3D printed grooved harness. In the cylindrical helical system 2000a, the transmit and receive coils were placed in the middle of the respective resonant coils as shown in FIG. 2. For this example spherical helical system 2000b, the location of the transmit and resonant coils 2112, 2118 were fixed by polymer spacers 2004 in the spherical support as shown in FIG. 20b.

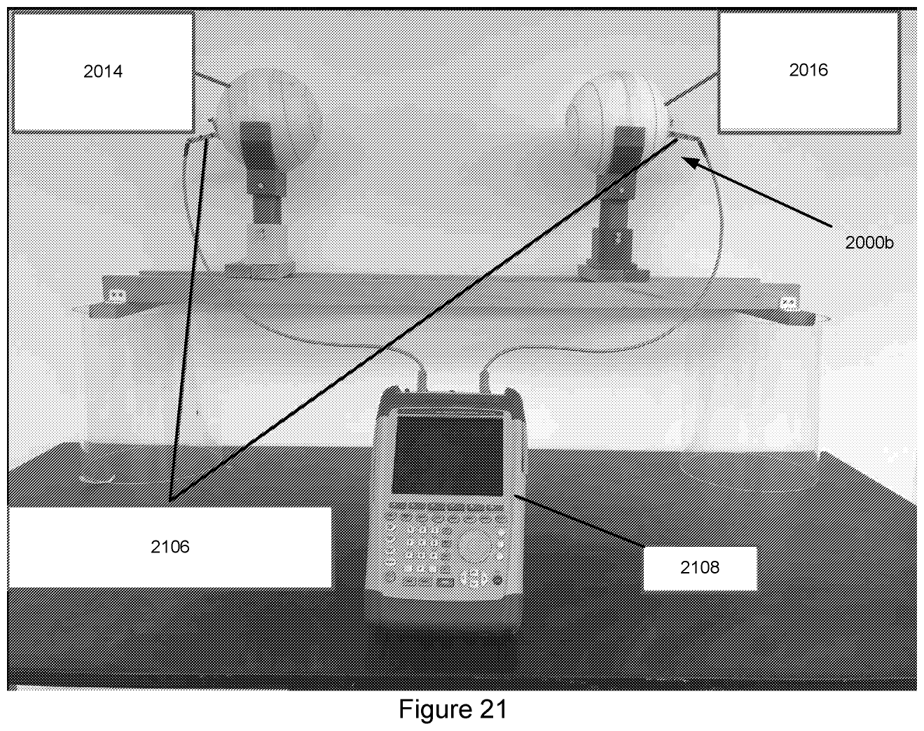

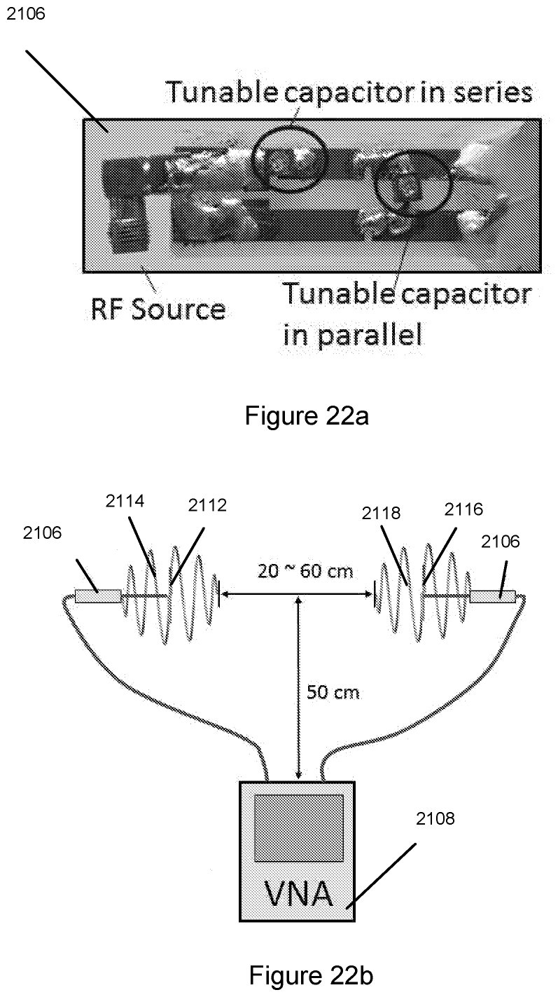

For example, the performance of example spherical helical system 2000b can be tested by connecting a vector network analyzer (VNA) 1008 (e.g. Rohde & Schwarz, ZVH8, 100 kHz to 8 GHz) to the coils as shown in FIG. 21. In this embodiment, the transmit coil 2112 was connected to port 1 of the VNA 2108 and the receive coil 2118 was connected to port 2 of the VNA through an impedance matching board 2106 with tunable capacitors. FIGS. 22a and 22b show details of a matching circuit board 2106 and preferably, the transmit and receive coils 2112, 2118 are tuned to match. Preferably, experiments are conducted in an open space to reduce interference from the surrounding. Advantageously, the transmission coefficients, S₁₁ and S₂₁ were measured allowing the transmission efficiency to be calculated.

To compare the performance of a spherical helical system (SHS) compared to a cylindrical helical system (CHS), a similar setup for a exemplary cylindrical system 2000a was created to measure transmission coefficients, S11 and S21 thereby allowing the transmission efficiency to be calculated.

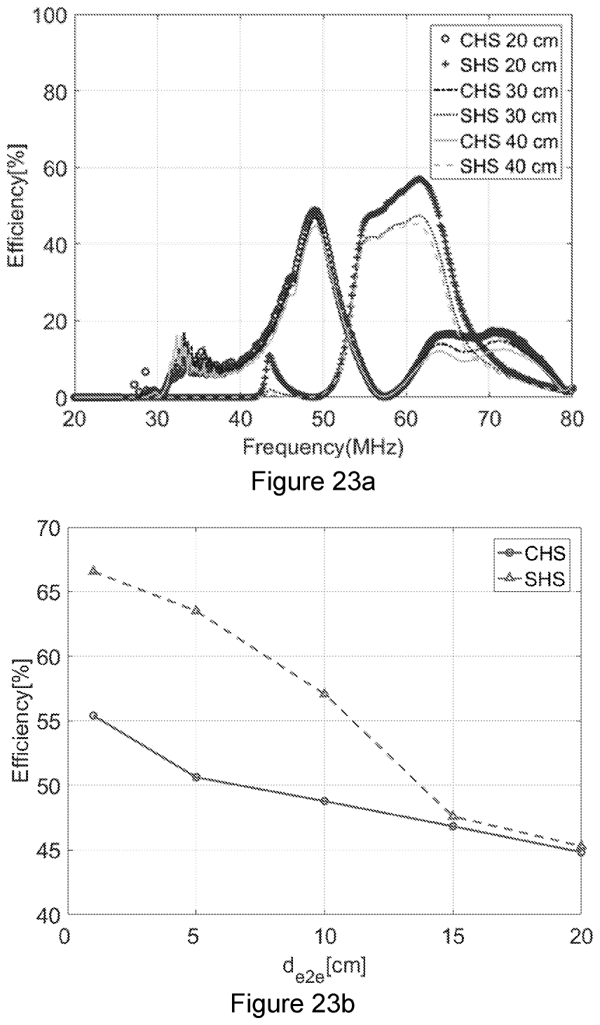

The experiment was conducted for varying transfer distances (also know as edge-to-edge distances) of 20 cm, 30 cm, 40 cm and exemplary results of efficiency for both systems are shown in FIG. 23a. The maximal efficiencies of both systems appear to be in the range of 40% to 50%, likely due to system loss. As shown in FIG. 23a, the bandwidth at a transfer distance of 40 cm was 14.5% over 40% efficiency for the SHS whilst the CHS had a bandwidth of 5.1%. Similar observations are obtained at the other two distances.

FIG. 23b shows the maximal efficiency of the two systems across the various transfer distance, dₑ₂ₑ. In this example, the maximal efficiency of the SHS was higher than the CHS and the efficiency appears to drop faster as the transfer distance increases. Experimental results from these exemplary systems demonstrate that spherical helical system 2000b appears to have a wider bandwidth at varying receiving distances without compromising on transmission efficiency as compared to cylindrical helical system 2000a.

### Sensitivity to Coil Alignment

To increase efficiency of power transfer between a transmit coil and a receive coil in a helical system, it is preferable for the receive coil to be aligned with the transmit coil. However, there are circumstances where this may not be possible and there may be some misalignment between the transmit and receive coil.

To investigate the sensitivity of a helical system when the receive coil is not perfectly aligned with a transmit coil, an exemplary sinusoidal helical system 800 with sinusoidal helical resonant coils 814, 816, was simulated and compared against a cylindrical helical system 200 with cylindrical helical resonant coils 214, 216. In this example, the transmit and receive coils are positioned outside the resonators.

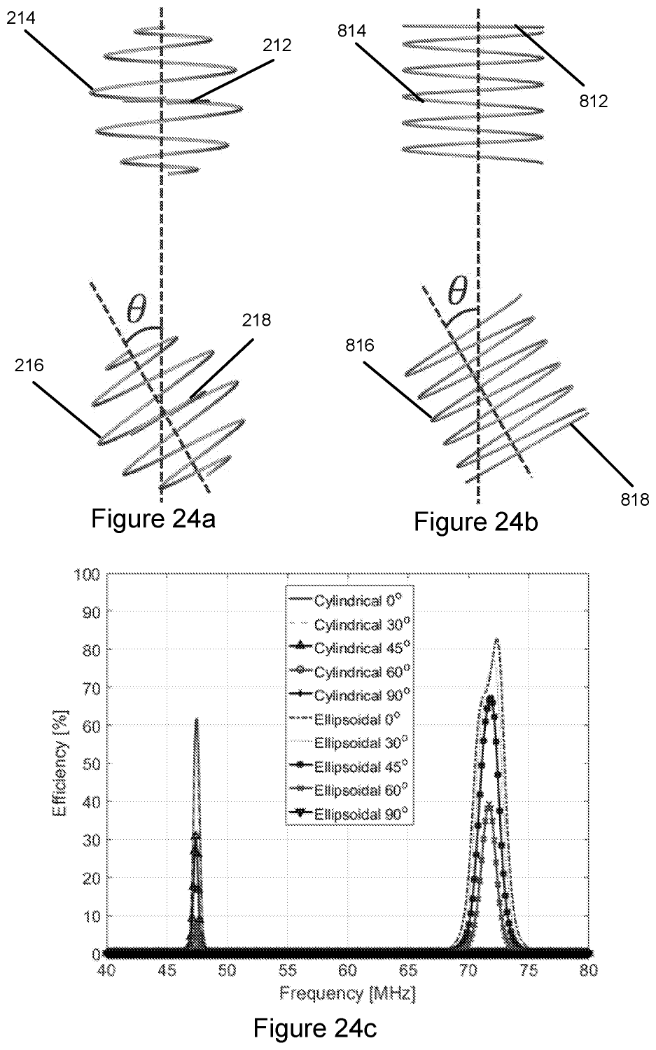

In this example, the distance between the receive and transmit resonators (dₑ₂ₑ) were kept to be 20 cm. The angle of misalignment between the receive and transmit coils, θ, is as particular shown for sinusoidal helical system 800 in FIG. 24a and for cylindrical helical system 200 in FIG. 24b. For this example, θ was set to be in the range of 0°˜90°. Preferably, no impedance is conducted at the transmit and receive coils to attain the intrinsic misalignment sensitivity of the systems.

FIG. 24b shows an example of simulation results for sinusoidal helical system 800 (ellipsoidal) and cylindrical helical system 200 (cylindrical) at various misalignment angles, θ. These results are itemised in the table below, including corresponding normalized values that are normalized to the maximum (the reading when θ=0°):

TABLE VII
MAXIMAL EFFICIENCY (NORMALIZED MAXIMAL
EFFICIENCY) AND BANDWIDTH (BW) OF WPT SYSTEMS
WITH ANGULAR MISALIGNMENTS

| | Cylindrical helical system | | | Ellipsoidal helical system | | |
|---|---|---|---|---|---|---|
| θ | Efficiency | | 40%-BW | Efficiency | | 40%-BW |
| 0° | 61.93% | (1) | 0.84% | 82.76% | (1) | 3.76% |
| 30° | 54.20% | (0.88) | 0.63% | 77.61% | (0.94) | 3.13% |
| 45° | 30.74% | (0.50) | 0 | 67.15% | (0.81) | 2.30% |
| 60° | 7.01% | (0.11) | 0 | 39.25% | (0.47) | 0 |
| 90° | .24% | (0.00) | 0 | 0.01% | (0.00) | 0 |

Note:
$normalized maximal efficiency = \frac{maximal efficiency at θ}{maximal efficiency at 0 °}$

The results show that the sinusoidal helical system 800 has a wider bandwidth and a higher maximum efficiency without impedance matching, for example by using a capacitor in series and another one in shunt. Moreover, it is observed that the change of the relative orientation between the transmit coil and the receive coil may not affect the resonant frequency of the system—the orientation appears affect the maximum value and the bandwidth of the system.

The results indicate that the maximum transmission efficiency for both systems decreases when θ increases and both systems indicate almost zero transmission efficiency when θ=90°. When the angle of misalignment is between 0 and 60°, the sinusoidal helical system 800 appears to have a higher normalized maximal efficiency compared to the cylindrical helical system 200—e.g., at θ=45°, the normalized maximal efficiency is 0.50 for the cylindrical helical system 200, while it is 0.81 for the sinusoidal helical system 800. In addition, the sinusoidal helical system 800 appears to exhibit a reasonable efficiency even when the transmit coil 812 and the receive coil 818 are very misaligned, e.g. θ=60° (i.e. the normalized maximal efficiency is 0.47).

It appears from the exemplary simulations above that the sinusoidal helical system 800 is less sensitive to misalignment compared to the cylindrical helical system 200 by appearing to have higher efficiency and wider bandwidth. This may be due to the geometry of the wound wire, for example the tapering of the coil. The tapering may correspond to resonance at a wider bandwidth compared to a structure with a uniform dimension (in the transversal plane), for example. This may also be due to a more symmetric 3D shape leading to a field distribution which is more spread out which allows for more angular misalignment for power transfer to take place.

### Semi-Ellipsoidal Helix & the Reflection Walls

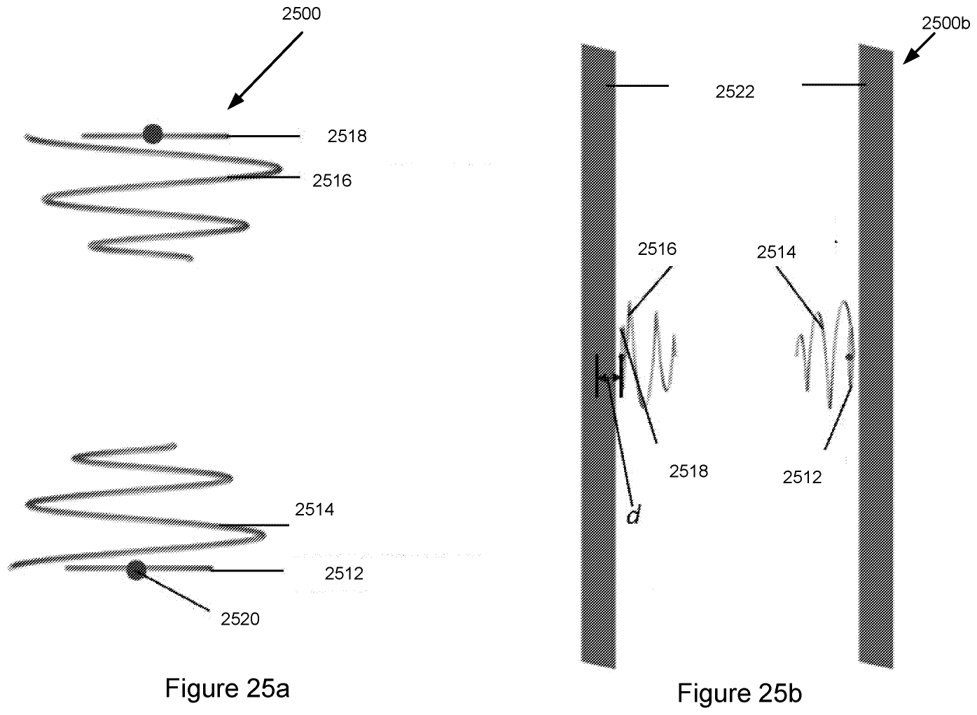

In wireless power transfer systems, it is preferable to capture maximum power at the receive coil and any energy emitted in the backward direction which is not captured by the receive coil may be wasted. The performance of a semi ellipsoidal helix system 2500 was simulated to investigate the effect of half a resonator 2516, 2514 being along a power link of a wireless power system as shown in FIG. 25a. In this example semi ellipsoidal helix system 2500, the transmit coil 2512 is placed in the middle of the transmit resonant coil 2514 and the receive coil 2518 is placed in the middle of receive resonant coil 2516 as shown in FIG. 25a. Preferably, the resonant coils 2514, 2516 are symmetric with respect to the coil.

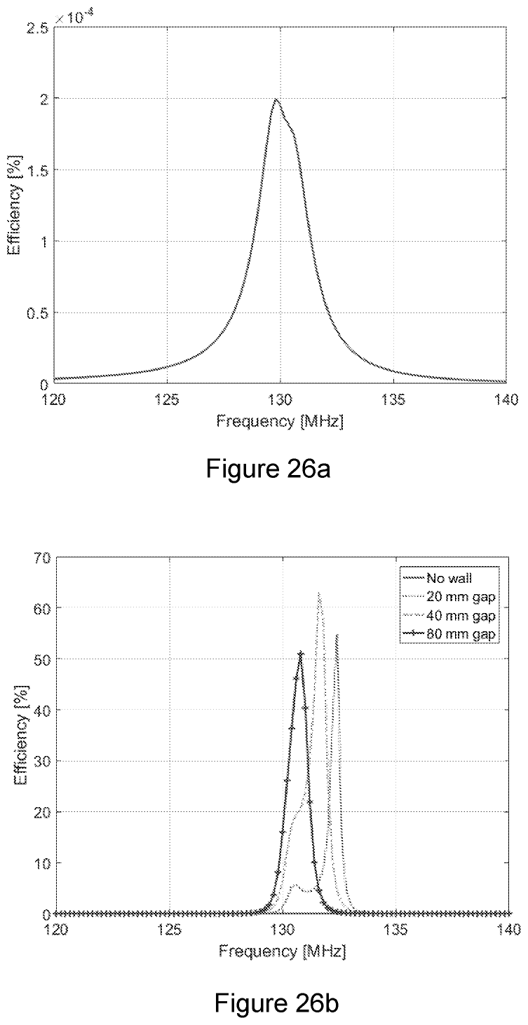

FIG. 26a shows example simulation results of the semi ellipsoidal helix system 2500 showing a plot of calculated transmission efficiency versus frequency based on the simulated transmission and reflection coefficients. It appears that the semi ellipsoidal helix system 2500 has an increase of resonant frequency, a dramatic decrease of transmission efficiency and the peak efficiency is only 0.02%.

FIG. 25b shows another example semi ellipsoidal helix system 2500b with reflection walls 2522, such as a metallic reflection wall, added to the back side of the transmit coil 2512 and the receive coil 2518 with semi-ellipsoidal resonant coils 2516, 2518. A number of simulations were conducted varying the distance between the walls 2522 and the transmit and receive coils 2512, 2518, d. For example, d was set to be 20 mm, 40 mm, and 80 mm.

FIG. 26b shows example simulation results based on the simulated S₁₁ and S₂₁ to calculate the transmission efficiency of semi ellipsoidal helix system 2500b with varying d. A simulation with no walls 2522 was also simulated for comparison (no wall) as shown in FIG. 26b.

The simulation results indicate that the reflection wall 2522 increases the transfer efficiency significantly by suppressing the backward radiation, for example. The 40%-efficiency-BW of the simulated semi ellipsoidal helix system 2500b with a d=20 mm, 40 mm, and 80 mm is 0.19%, 0.38%, and 0.41% centred at 132.4 MHz, 131.6 MHz, and 130.8 MHz, respectively. The simulated semi ellipsoidal helix system 2500b shows a peak efficiency of 54.86%, 62.92%, and 50.94% for d=20 mm, 40 mm, and 80 mm, respectively.

The simulations results indicate that the gap, d, has an effect on the performance of the semi ellipsoidal helix system 2500b in terms of the resonant frequency, the bandwidth, and the maximum efficiency. It appears that when the gap increases, the resonant frequency decreases and the bandwidth becomes larger. In the example simulations, the semi ellipsoidal helix system 2500b with a gap of 40 mm shows the highest transmission efficiency (62.92%). This may be due to a constructive interference of the reflected waves from the reflection walls.

The simulations appear to indicate that semi ellipsoidal helix system 2500b without reflection walls have lower transmission efficiency compared to semi ellipsoidal helix system 2500b with reflection walls although semi ellipsoidal helix system 2500b with reflection walls show transmission of narrow bandwidths. This indicates that the other half of an ellipsoidal helix i.e. that which is not along the power link, may contribute effectively to a wideband reflection of the energy back to the link.

Additionally, the resonant frequencies of the semi ellipsoidal helix system 2500b are almost double that of a ellipsoidal helix system—this may not be desirable in applications where a low operating frequency and small physical size of a resonator is preferred. In some embodiments, high frequency systems may result in difficulties in rectifying a circuit design.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge.

1.-22. (canceled)

23. A wireless power transfer apparatus including:
(a) a first resonator having a resonant frequency; and
(b) a first coil located within the first resonator;
wherein the resonator is configured to inductively couple to a second resonator having a resonant frequency that is the same as the resonant frequency of the first resonator to thereby transmit power to, or receive power from, the second resonator.

24. The apparatus of claim 23, wherein the first coil is located substantially centrally within the first resonator.

25. The apparatus of claim 23, wherein the first resonator comprises an ellipsoidal helical coil.

26. The apparatus of claim 25, wherein the ellipsoidal helical coil has one of the following shapes:
(a) a sinusoidal or semi-sinusoidal helix;
(b) a circular helix;
(c) a linear helix; or
(d) a concave helix.

27. The apparatus of claim 26, wherein the ellipsoidal helical coil is parametrised by the equations x(t)=R·A(t)·cos(t), y(t)=R·A(t)·sin(t), z(t)=R·\sqrt{1−A²(t)}, where R is a radius of the ellipsoidal helical coil at its centre, t is a parametric variable in the range [−nπ, nπ], n is a number of turns of the ellipsoidal helical coil, and A(t) is a tapering function defining tapering of the ellipsoidal helical coil from its centre to either of its ends.

28. The apparatus of claim 27, wherein the tapering function is one of:
$$A ( t ) = cos ( \frac{t}{N} ) , where N = 12 ;$$
$$A ( t ) = \sqrt{1 - {( t \text{/} π )}^{2}} ;$$
$$A ( t ) = 1 - sign ( t ) \cdot t \text{/} ( 6 π ) ; and$$
$$A ( t ) = 1 - \sqrt{1 - {( t \text{/} ( 6 π ) - sign ( t ) )}^{2}} .$$

29. The apparatus of claim 25, wherein the ellipsoidal helical coil is elongated along its main axis, and/or is compressed in a direction substantially perpendicular to its main axis.

30. The apparatus of claim 29, wherein the ellipsoidal helical coil is elongated by a length that is half the distance between the ends of the ellipsoidal helical coil.

31. The apparatus of claim 29, wherein the ellipsoidal helical coil is compressed by a length that is half the diameter of the ellipsoidal helical coil.

32. The apparatus of claim 25, further including one or more reflecting walls at one end of the ellipsoidal helical coil.

33. A wireless power transfer apparatus, including a first resonator having a resonant frequency; and a first coil configured to electromagnetically couple to the first resonator; wherein the first resonator is configured to inductively couple to a second resonator having a resonant frequency that is the same as the resonant frequency of the first resonator to thereby transmit power to, or receive power from, the second resonator; and wherein the first resonator comprises an ellipsoidal helical coil.

34. The apparatus of claim 33, wherein the first coil is located within the first resonator.

35. The apparatus of claim 34, wherein the first coil is located substantially centrally within the first resonator.

36. The apparatus of claim 33, wherein the ellipsoidal helical coil has one of the following shapes:
(a) a sinusoidal or semi-sinusoidal helix;
(b) a circular helix;
(c) a linear helix; or
(d) a concave helix.

37. The apparatus of claim 33, wherein the ellipsoidal helical coil is parametrised by the equations x(t)=R·A(t)·cos(t), y(t)=R·A(t)·sin(t), z(t)=R·\sqrt{1−A²(t)}, where R is a radius of the ellipsoidal helical coil at its centre, t is a parametric variable in the range [−nπ, nπ], n is a number of turns of the ellipsoidal helical coil, and A(t) is a tapering function defining tapering of the ellipsoidal helical coil from its centre to either of its ends.

38. The apparatus of claim 37, wherein the tapering function is one of:
$$A ( t ) = cos ( \frac{t}{N} ) , where N = 12 ;$$
$$A ( t ) = \sqrt{1 - {( t \text{/} π )}^{2}} ;$$
$$A ( t ) = 1 - sign ( t ) \cdot t \text{/} ( 6 π ) ; and$$
$$A ( t ) = 1 - \sqrt{1 - {( t \text{/} ( 6 π ) - sign ( t ) )}^{2}} .$$

39. The apparatus of claim 33, wherein the ellipsoidal helical coil is elongated along its main axis, and/or is compressed in a direction substantially perpendicular to its main axis.

40. The apparatus of claim 39, wherein the ellipsoidal helical coil is elongated by a length that is half the distance between the ends of the ellipsoidal helical coil.

41. The apparatus of claim 39, wherein the ellipsoidal helical coil is compressed by a length that is half the diameter of the ellipsoidal helical coil.

42. The apparatus of claim 33, further including one or more reflecting walls at one end of the ellipsoidal helical coil.
